(19) United States
(12) Patent Application Publication
(10) Pub. No.: US 2015/0321289 A1
(43) Pub. Date: Nov. 12, 2015

(54) LASER DEPOSITION OF METAL FOAM

(71) Applicant: Siemens Energy, Inc., Orlando, FL (US)

(72) Inventors: Gerald J. Bruck, Oviedo, FL (US); Ahmed Kamel, Orlando, FL (US)

(73) Assignee: Siemens Energy, Inc., Orlando, FL (US)

(21) Appl. No.: 14/274,952

(22) Filed: May 12, 2014

(51) Int. Cl. B23K 26/34; B23K 26/00; B05D 1/38; B23K 26/12; B05D 3/02; B05D 1/12

(52) U.S. Cl. CPC B23K 26/345; B05D 3/0254; B05D 1/12; B05D 1/38; B23K 26/126; B23K 26/0012; B33Y 10/00

(57) ABSTRACT

A layer of superalloy metal foam (20) is deposited onto a superalloy substrate (14) by laser melting (16) a powder mixture (10) containing particles of a superalloy metal (22) and particles of a foaming agent (24). A gas turbine engine component (30) is formed to include such metal foam. A ceramic thermal barrier coating material (31) may be applied directly over the metal foam without an intervening bond coat layer.

### FIELD OF THE INVENTION

This invention relates generally to the field of materials technology, and more specifically to methods of forming metal foams and components formed thereof.

### BACKGROUND OF THE INVENTION

Metal foams are cellular structures including a large volume fraction of pores. While most metal structures contain some porosity, for example a few volume percent, metal foams may typically contain at least 75% volume fraction of pores.

Metal foams can be formed in several ways: by injecting gas into molten metal; by forming gas in-situ in molten metal through a chemical reaction; by lowering pressure to precipitate gas that is already present in molten metal; or by incorporating hollow beads of a higher melting temperature metal into molten metal having a lower melting temperature.

Metal foams and other highly porous materials have been used in the medical field for prosthetics and bone attachment applications, and in the aerospace and automobile fields for forming light weight structural components. U.S. Pat. No. 7,780,420 discloses a gas turbine engine compressor blade incorporating foam metal leading and trailing edges. In spite of a large number of patents describing metal foams, their commercial use in the power generation field has been extremely limited due to the difficulty of manufacturing such materials in commercially practical forms.

### BRIEF DESCRIPTION OF THE DRAWINGS

The invention is explained in the following description in view of the drawings that show:

FIG. 1 is an illustration of a material additive process producing a layer of superalloy metal foam on a surface of a superalloy substrate.

FIG. 2 is a cross-sectional view of a ceramic thermal barrier coating applied directly to a layer of metal foam on a superalloy component substrate without an intervening bond coat layer.

FIG. 3 is a cross-sectional view of a gas turbine engine blade having superalloy metal foam along its leading and trailing edges.

### DETAILED DESCRIPTION OF THE INVENTION

The present inventors have recognized a need for an improved method of manufacturing metal foam, particularly for manufacturing superalloy metal foam material that may be suitable for use in fabricating hot gas path components for gas turbine engines.

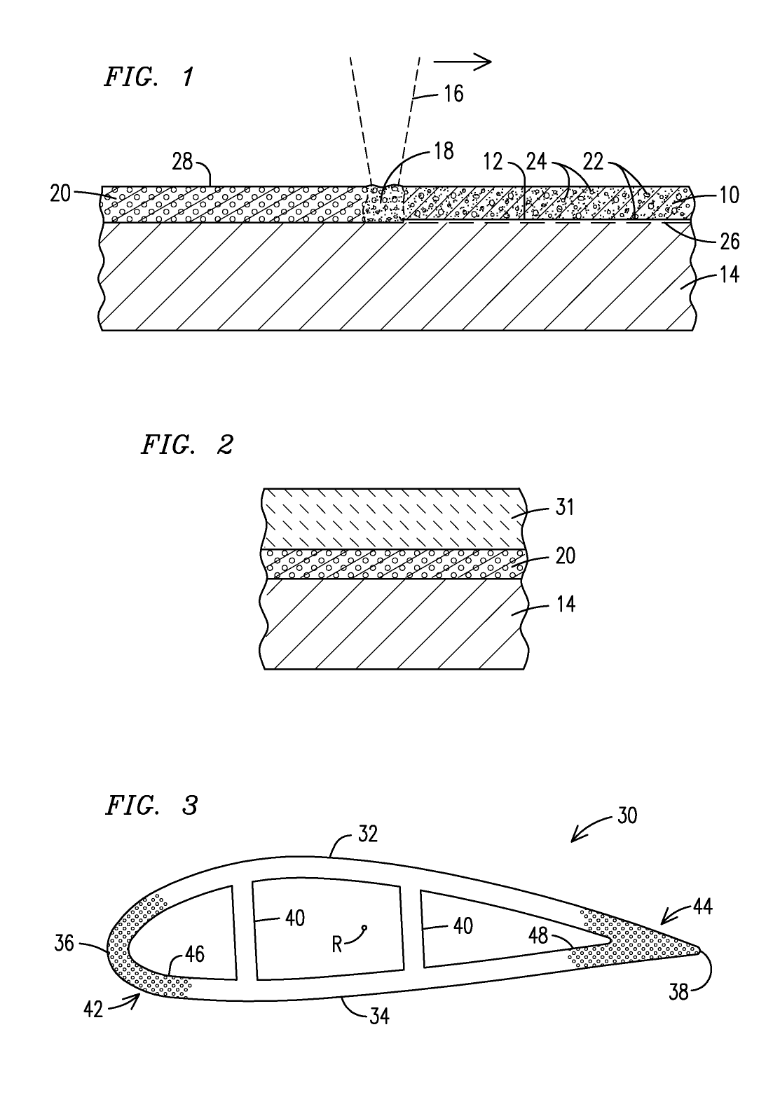

FIG. 1 illustrates an embodiment of such an improved method, wherein a powder mixture 10 deposited onto a surface 12 of a substrate 14 is melted with an energy beam 16 to form a melt pool 18, which then is allowed to solidify to form a layer of metal foam 20 on the substrate 14. The powder mixture 10 includes particles of metal 22 and particles of a foaming agent 24.

The term “metal” is used herein in a general sense to include both pure metals and metal alloys, and in the embodiment of FIG. 1, the substrate 14 and the particles of metal 22 are a superalloy material such as may be used in a gas turbine engine application, for example the materials sold under the trademarks or brand names IN 700, IN 939, Rene 80, CM 247, CMSX-8, CMSX-10, PWA 1484, and many others as are known in the art.

The foaming agent 24 can be any material that will release a gas upon being heated into the melt pool 18. One such foaming agent 24 is titanium hydride (TiH₂) which releases hydrogen gas into the melt pool 18. Upon solidification, the gas bubbles form porosity in the metal foam 20 of at least 50% by volume, or 50-85% or more by volume in some embodiments. The layer of metal foam 20 is integrally and metallurgically bonded to the underlying substrate 14 because a thin topmost surface layer 26 of the substrate 14 is melted by the energy beam 16 and is incorporated into the melt pool 18, thus ensuring that the layer of metal foam 20 is strongly adhered to the substrate 14. The energy beam 16, which may typically be a laser beam, is traversed across the surface 12 as indicated by the arrow, with beam frequency, energy level and speed being controlled to achieve a desired heat input.

Laser and process parameters may also be adjusted to achieve a stirring action to further enhance the function of the foaming agent (akin to breaking up effervescent tablets for heart burn relief to create a froth or foam). For example, a high density beam can create a vapor supported depression within the melt which when moved from side to side can act as a stirring element. Parameters may also be adjusted to achieve waves in the melt and a breaking action to entrain air or process gas by turbulent agitation (akin to sea water breaking on a beach causing sea foam).

Other volatile constituents may also act as foaming agents. For example, it is known that metal powders exposed to humidity will retain water and will result in porous metal deposits during laser cladding. Intentional humidification of powder may therefore be used to enhance the void volume fraction of the deposit. Similarly, it has been found by the inventors that yttria containing metal powders result in more porosity than yttria free powders. As yttria can also be advantageous in superalloy coatings, such foaming agent may have multiple benefits.

The foaming agent may further include ingredients (ceramics and/or alloying elements) that (a) reduce surface tension and inhibit bubble coalescence, or (b) increase viscosity and impede buoyancy of bubbles, thereby enhancing foam creation. Exclusion of ingredients that counter these effects is equally important. The levels of sulfur and oxygen are, for example, highly influential on surface tension, with both having low surface tension. Low levels of elements that reduce oxygen can have similar effects, for example aluminum. Similarly, low levels of silicon may be important in improved viscosity of the melt.

The foaming agent 24 may be a material that is beneficial to the desired properties of the layer of metal foam 20. For example, titanium is a common strengthening element used in superalloy compositions, so its release from the aforementioned TiH₂ and its mixing with the molten superalloy particles 22 can result in a desirable material composition of the superalloy metal foam 20. Hydrides of other metals present in the superalloy metal particles 22 and/or the superalloy substrate 14 may be used, such as tantalum hydride (TaH₂), magnesium hydride (MgH₂), zirconium hydride (ZrH₂) and combinations thereof.

The foaming agent 24 may be a material that performs a fluxing function in the melt pool 18. For example, calcium, magnesium and/or manganese carbides will contribute to the removal of sulfur by way of the formation of a removable slag. These compounds, and carbonates of the same elements, will form carbon monoxide and/or carbon dioxide gases to create the desired porosity. The gas also provides a degree of shielding of the melt pool 18 from the atmosphere.

In order to trap the gas produced by the foaming agent 24 within the re-solidifying molten metal to optimize the formation of porosity, it may be preferred to achieve a relatively rapid melting and re-solidification of the melt pool 18. As such, it may prove advantageous in some embodiments to utilize a pulsed laser beam 16 rather than a continuous energy source. By pulsing relatively short bursts of relatively high levels of energy followed by periods of no energy addition, it is possible to more effectively trap relatively smaller pockets of gas in the solidifying metal than when applying the same total amount of energy via a continuous energy beam source.

The process of FIG. 1 has application as a technique for modifying the surface of a superalloy component. It is known to apply a bond coat material, such as an MCrAlY material, between a superalloy component substrate and an overlying ceramic thermal barrier coating material in order to enhance adhesion and to accommodate the difference in coefficient of thermal expansion between the superalloy substrate and the ceramic thermal barrier coating material. The process of FIG. 1 may be used to apply a layer of superalloy metal foam 20 to the substrate 14 prior to the application of a bond coat material. The relatively rough surface 28 of the metal foam 20 caused by surface opening porosity promotes good adhesion of any overlying coating material. Moreover, the porosity of the metal foam 20 provides a degree of mechanical compliance that will alleviate differential thermal expansion stresses, thus allowing a ceramic thermal barrier coating 31 to be applied directly to a layer of metal foam 20 on a superalloy substrate 14 without an intervening bond coat layer in some applications, as shown in FIG. 2.

The process of FIG. 1 also has application in the additive manufacturing of components. FIG. 3 is top view of a gas turbine engine blade 30 during a stage of additive manufacturing. The blade 30 has an airfoil shape with a suction side 32 and a pressure side 34 extending from a leading edge 36 to a trailing edge 38. The blade 30 is being manufactured by depositing a plurality of layers of superalloy material to build the blade 30 along a radial axis R extending out of the plane of FIG. 3, with a most recently deposited layer visible in the figure. A majority of the pressure 34 and suction 32 sides, as well as structural webs 40 extending there between, are deposited as essentially fully dense superalloy material by a laser deposition process in accordance with a known prior art process. However, regions 42, 44 proximate the leading edge 36 and trailing edge 38 respectively are deposited to be metal foam 20 in accordance with the process illustrated in FIG. 1. Regions 42, 44 may be produced from powder containing both metal 22 and foaming agent 24 particles as compared to the other regions of the airfoil shape that are produced from powder containing only metal particles (or metal only and flux). The powder may be pre-placed layer by layer or it may be directed into the energy beam as it traverses across the airfoil shape in a continuous process.

The quantity of foaming agent particles 24 as a percentage of the total powder mixture 10 may be constant, such as less than 1%, or it may vary in different regions of the blade 30. It is recognized that density and strength have a non-linear relationship, and in regions of relatively lower operating stress, the amount of foaming agent 24 and the resulting degree of porosity may be increased in order to reduce the weight of the blade 30, as compared to regions of relatively higher operating stress which are formed to have lower or no porosity.

A layer of metal foam 20 deposited on a component substrate surface 12 in accordance with the present invention provides several advantages for gas turbine component applications. The metal foam 20 may provide improved thermo-mechanical fatigue resistance, since the foamed material is relatively flexible and crack resistant because of the thin metal ligaments between pores. If cracks do form in the foam material, the cracks would likely be arrested by an adjoining pore, thereby preventing propagation of the crack into the underlying substrate material 14. The metal foam 20 may also provide improved resilience to foreign object damage, since foamed materials are generally characterized by ballistic impact advantages. Moreover, the metal foam 20 may provide improved cooling when formed along a cooling channel surface 46, 48 due to transpiration cooling to the extent that the regions 42, 44 contain open porosity, thereby reducing or eliminating the need for drilled cooling holes.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. A method comprising:
depositing a powder mixture comprising metal and a foaming agent onto a substrate;
heating the powder mixture with an energy beam to form a melt pool comprising molten metal and gas generated by the heated foaming agent; and
allowing the melt pool to solidify to form a layer of metal foam on the substrate.

2. The method of claim 1, further comprising heating the powder mixture with a pulsed laser beam.

3. The method of claim 1, further comprising depositing the powder mixture comprising particles of superalloy material onto a superalloy material substrate.

4. The method of claim 3, wherein the foaming agent comprises at least one of the group of calcium carbonate, magnesium carbonate, manganese carbonate, calcium carbide, magnesium carbide and manganese carbide.

5. The method of claim 3, wherein the foaming agent comprises at least one of the group of titanium hydride, tantalum hydride, magnesium hydride and zirconium hydride.

6. The method of claim 3, wherein the foaming agent comprises an elemental constituent of the powder particles of the superalloy material or the superalloy material substrate.

7. The method of claim 1, further comprising depositing a ceramic thermal barrier coating material onto the layer of metal foam without an intervening bond coat layer.

8. The method of claim 1, further comprising controlling the energy beam to cause melt pool action effective to entrain gas in the solidifying melt pool.

9. The method of claim 1, further comprising exposing the powder mixture to humidity to retain water therein as the foaming agent prior to the step of heating.

10. The method of claim 1, further comprising selecting the powder mixture to comprise yttria.

11. The method of claim 1, further comprising selecting the powder mixture to comprise an ingredient effective to reduce surface tension of the melt pool.

12. The method of claim 1, further comprising selecting the powder mixture to comprise an ingredient effective to increase viscosity of the melt pool.

13. A method comprising forming a superalloy component by additive manufacturing by successively depositing a plurality of layers of superalloy material to form a near net shape of the component, each layer deposited by melting with an energy beam a layer of superalloy material powder deposited on a predecessor layer, the method characterized by:
including a foaming agent in at least one of the layers of superalloy material powder, the foaming agent effective to produce gas during the melting such that the deposited layer of superalloy material comprises metal foam.

14. The method of claim 13, wherein the metal foam is disposed in a region of the component designed to an operating stress level that is lower than a design operating stress level of a region of the component that does not include the metal foam.

15. The method of claim 13, further characterized by:
forming the near net shape to comprise an airfoil; and
including the particles of foaming agent proximate at least one of a leading edge and a trailing edge of the airfoil.

16. The method of claim 13, further characterized by including particles of the foaming agent to form the metal foam along a cooling channel surface of the component.

17. The method of claim 13, further characterized by depositing a ceramic thermal barrier coating material over the metal foam without an intervening bond coat layer.

18. The method of claim 13, wherein the foaming agent comprises at least one of the group of calcium carbonate, magnesium carbonate, manganese carbonate, calcium carbide, magnesium carbide and manganese carbide.

19. The method of claim 13, wherein the foaming agent comprises at least one of the group of titanium hydride, tantalum hydride, magnesium hydride and zirconium hydride.

20. The method of claim 13, wherein the foaming agent comprises an elemental constituent of the superalloy material.

21. A method comprising:
forming a portion of a superalloy component by successively depositing a plurality of layers of superalloy material, each layer deposited by melting a layer of superalloy material powder with an energy beam: and
altering a composition of the superalloy material powder in at least a portion of at least one of the layers such that the portion of the at least one layer of superalloy material is more crack resistant than a portion of the superalloy material deposited without altering the composition.

22. The method of claim 21, further comprising altering the composition of the superalloy material powder by including a foaming agent such that the portion of the at least one layer comprises a metal foam.

23. The method of claim 22, wherein the foaming agent comprises particles of a material that produces a gas during the melting.

24. The method of claim 22, wherein the foaming agent comprises water retained in the superalloy material powder.

25. The method of claim 21, wherein the superalloy component is a gas turbine engine airfoil, and the portion of the at least one layer is disposed proximate a leading edge or a trailing edge of the airfoil.

26. The method of claim 21, wherein the portion of the at least one layer is disposed along a cooling channel surface of the superalloy component.

27. A superalloy gas turbine engine component formed by the method of claim 21.
